(19) United States
(12) Patent Application Publication
(10) Pub. No.: US 2003/0099015 A1
(43) Pub. Date: May 29, 2003

(54) Avoiding amplified spontaneous emission loops in optical networks

(75) Inventors: Colin Geoffrey Kelly, Manotick (CA); Ping Wai Wan, Kanata (CA)

Correspondence Address: TROPIC NETWORKS INC., DR. VICTORIA DONNELLY, 135 MICHAEL COWPLAND DRIVE, KANATA, ON, K2M 2E9, CA

(73) Assignee: AR card

(21) Appl. No.: 09/990,384

(22) Filed: Nov. 23, 2001

(51) Int. Cl. H04B 10/20; H04J 14/00; H04J 14/02

(52) U.S. Cl. 359/127; 359/119

(57) ABSTRACT

An optical network comprises nodes coupled via optical fibers and forming one or more loops each comprising a plurality of the nodes. Amplified spontaneous emission (ASE) loops in the network are avoided by providing, for each loop, optical seam filters, which may include add/drop multiplexer functions, for different spectral bands of an optical spectrum of the network in different ones of the nodes of the loop. Each optical seam filter optically interrupts the loop for optical wavelengths within the respective spectral band, so that each loop is optically interrupted for all spectral bands of the optical spectrum.

This invention relates to optical networks, and is particularly concerned with avoiding amplified spontaneous emission (ASE) loops in optical networks, in particular optical WDM (wavelength division multiplex) networks.

### BACKGROUND

Optical networks typically incorporate fiber rings or mesh arrangements, which can contain closed optical loops at one or more frequencies, or optical wavelengths, within the optical spectrum. In an optical network including amplifiers, inherent losses of such an optical loop can be sufficiently compensated by amplifier gain that the net loss around the loop is too small to prevent an excessive noise build-up (or there can be a net gain around the loop, resulting in a lasing fiber loop). The noise build-up in such an amplified optical network is dominated by amplified spontaneous emission (ASE) noise, and such loops are referred to as ASE gain loops or, more briefly, ASE loops.

An ASE loop at any optical wavelength in an optical network can have a significant adverse impact on optical signals at all wavelengths carried by an optical fiber, causing partial or complete loss of communications as a result of degraded SNR (signal to noise ratio). Consequently, it is necessary to avoid any ASE loops in an optical network.

One known method of avoiding ASE loops in an optical network is to identify all potential loops, and to use careful power management to ensure that any optical loops have sufficient loss that ASE build-up does not occur. This approach is not generally robust or flexible in that, depending on the network connectivity and topology, it may be difficult to meet optical link budget constraints while simultaneously preventing excessive noise amplification.

Another known method of avoiding ASE loops in an optical network is to provide a complete break in each optical path which could otherwise form an optical loop, whereby optical loops are avoided. For example, in a hubbed ring all optical signals can be terminated (converted to electrical signals) at a hub site, the hub site thereby interrupting the optical loop and converting it into an arc. While this can be cost effective for simple hubbed rings, because no additional electro-optical equipment may be required, it makes the network topology inflexible. In general, it requires that all optical wavelengths be terminated at the hub site, including any wavelengths for which such termination is not required for grooming purposes, resulting in undesired optical transceiver costs.

This method can also be applied to physical mesh networks by restricting the fiber connectivity to linear segments that are interconnected through hub sites which, depending on the network connectivity, may not need to be complete hubs. The same disadvantages as recited above apply, and general application of this method to mesh networks, especially those based on interconnected rings, may be unduly restrictive and therefore not practical.

A further known method of avoiding ASE loops in an optical network is to selectively break each loop using a selective filter which passes only desired wavelengths, other wavelengths being blocked by the filter to avoid optical loops at these wavelengths. The selective filter can be static (i.e. using fixed-wavelength optical filters) or dynamic.

A dynamic filter arrangement requires demultiplexing and multiplexing of every wavelength or waveband (group of wavelengths) that may possibly exist on the respective fiber path, with EVOAs (electrically controlled variable optical attenuators) or optical switches between the demultiplexer and multiplexer. A particular wavelength or waveband that is not being used on the respective fiber path can be attenuated by the appropriate EVOA or optical switch, thereby eliminating any possible loop gain in that portion of the optical spectrum. Other wavelengths or wavebands, which are being used, are not similarly attenuated by the dynamic filter, under the reasonable assumption that these are dropped and added elsewhere, so that an optical loop in their part of the optical spectrum is avoided by what is referred to as an “optical seam” at the add/drop location.

This method is more effective for waveband-routed optical networks than for wavelength-routed networks, because a wavelength-routed network, with broadband optical amplifiers, would require each wavelength to be demultiplexed and multiplexed by each dynamic filter, resulting in additional costs, excessive filter losses, and bandwidth-narrowing effects due to cascaded filters.

An advantage of this method using dynamic selective filters is that it can be flexible to changes in the network routing. Disadvantages include the high costs for a full set of demultiplexing and multiplexing filters, and associated optical attenuators or switches, for each dynamic filter (a broadband amplified ring network requires one dynamic filter, and a physical mesh network requires a dynamic filter for each potential optical loop), and the losses of the additional filters, resulting in additional gain requirements and further network costs.

Accordingly, there is a need for an improved method of avoiding ASE loops in optical networks, and for correspondingly improved optical networks.

### SUMMARY OF THE INVENTION

According to one aspect of this invention there is provided a method of avoiding an amplified spontaneous emission (ASE) loop in an optical network comprising a plurality of nodes coupled via optical paths, the nodes and optical paths forming a loop in the network, comprising the steps of: dividing an optical spectrum of the optical network into a plurality of separate spectral bands; and providing a plurality of optical seam filters, each optically interrupting optical signals in a respective spectral band, distributed among a plurality of nodes around the loop whereby optical signals in at least one spectral band are optically interrupted in a different node from optical signals in at least one other spectral band, the optical seam filters providing at least one optical interruption around the loop for each spectral band.

The optical seam filters are also arranged to provide sufficient loss at the edges of the spectral bands to ensure that any part of the optical spectrum between adjacent spectral bands is sufficiently attenuated to avoid excessive noise gain in these inter-band regions.

The method preferably includes the step of, for at least one node including an optical seam filter for a spectral band, add/drop multiplexing optical signals of the spectral band at the node. Thus with appropriate filter and network design, the same filter can provide both the optical seam filtering and add/drop filtering for the spectral band. Thus an optical loop is optically interrupted, at different nodes for different spectral bands, or parts of the optical spectrum, in a manner that can be combined with add/drop filtering in the nodes, thereby avoiding an ASE loop while requiring little or no additional equipment such as optical transceivers or filters, and hence in a cost-effective manner.

The optical spectrum can for example be divided into at least two non-overlapping spectral bands each including a plurality of optical wavelengths, or into at least two spectral bands having interleaved optical wavelengths.

The invention further provides a method of avoiding amplified spontaneous emission (ASE) loops in an optical network comprising a plurality of nodes coupled via optical paths, the nodes and optical paths forming a plurality of loops in the network, comprising avoiding an ASE loop in each of a plurality of said loops by the method recited above.

Another aspect of the invention provides an optical network comprising a plurality of nodes coupled via optical paths, the nodes and paths forming a loop in the network, wherein an optical spectrum for communications among the nodes via the optical paths comprises a plurality of separate spectral bands, and wherein a plurality of nodes in the loop each comprise at least one optical seam filter for optically interrupting the loop for optical signals in a respective one of the spectral bands, all of the spectral bands of the optical spectrum thereby being optically interrupted by respective optical seam filters distributed among at least two nodes in the loop.

Conveniently, at least one of the plurality of nodes in the loop comprising an optical seam filter further comprises an optical add/drop multiplexer for add/drop multiplexing optical signals of the respective spectral band at the node.

The invention further provides an optical network comprising a plurality of nodes coupled via optical paths, the nodes and paths forming a plurality of loops in the network, wherein an optical spectrum for communications among the nodes via the optical paths comprises a plurality of separate spectral bands, and wherein a plurality of nodes in each of a plurality of the loops each comprise at least one optical seam filter for optically interrupting the respective loop for optical signals in a respective one of the spectral bands, all of the spectral bands of the optical spectrum thereby being optically interrupted by respective optical seam filters distributed among at least two nodes in the respective one of the plurality of loops.

A further aspect of the invention provides a method of avoiding amplified spontaneous emission (ASE) loops in an optical network comprising nodes coupled via optical fibers, comprising the steps of, in each of one or more loops each comprising a plurality of the nodes: providing an optical seam filter for a first spectral band of an optical spectrum of the optical network in a first one of the nodes of the loop thereby to optically interrupt the loop for optical wavelengths within said first spectral band; and providing an optical seam filter for at least one other spectral band of the optical spectrum in at least one other of the nodes of the loop, thereby to optically interrupt the loop for optical wavelengths in said at least one other spectral band, whereby the loop is optically interrupted for all spectral bands of the optical spectrum.

### BRIEF DESCRIPTION OF THE DRAWINGS

The invention will be further understood from the following description by way of example with reference to the accompanying drawings, in which:

FIG. 1 schematically illustrates parts of a WDM optical network comprising a fiber ring, with reference to which a problem addressed by this invention is explained;

FIG. 2 illustrates optical loop gain as a function of frequency within the optical spectrum of the network of FIG. 1;

FIG. 3 schematically illustrates parts of a WDM optical network comprising a fiber ring, in accordance with an embodiment of this invention;

FIGS. 4 and 5 schematically illustrate optical seam filters of the network of FIG. 3;

FIG. 6 illustrates gain as a function of wavelength of the optical seam filters of FIGS. 4 and 5;

FIG. 7 schematically illustrates parts of a WDM optical network in accordance with another embodiment of this invention; and

FIG. 8 schematically illustrates another form of optical seam filter which can be used in embodiments of the invention.

### DETAILED DESCRIPTION

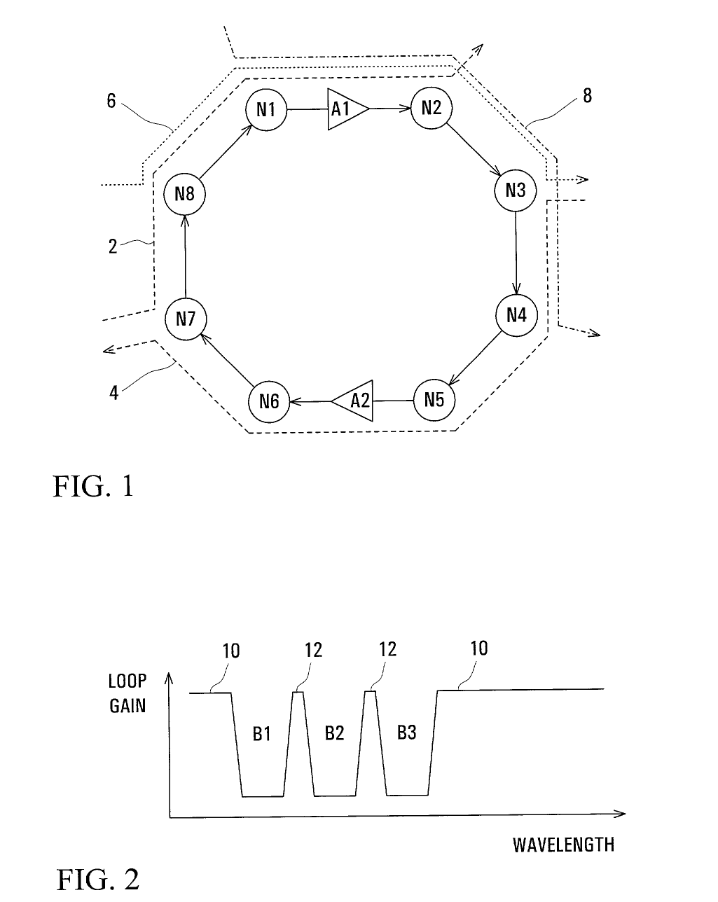

Each of FIGS. 1, 3, and 7 of the drawings schematically illustrates parts of a WDM optical network comprising optical fibers which are physically coupled between nodes to form a fiber ring. The nodes are represented by circles, and in each case there are by way of example eight nodes referenced N1 to N8. The physical connectivity of the fibers is represented by solid lines between the nodes. Optical amplifiers in the fiber ring are represented conventionally by triangles, and by way of example in each case two such amplifiers are illustrated and referenced A1 and A2.

It can be appreciated that the arrangements of FIGS. 1, 3, and 7 are given purely by way of example. In general, an optical network can comprise arbitrary numbers of nodes and amplifiers, and these can be provided in various arbitrary arrangements, including physical fiber rings, cascaded rings, and arbitrary fiber meshes. In any of these a plurality of nodes and optical paths can form one or more loops. In the optical ring arrangements of FIGS. 1, 3, and 7 such a loop is inherent in the ring itself; accordingly these arrangements are convenient for explaining the principles of the invention. However, it can be appreciated that these principles are, and the invention is, equally applicable to each loop in any optical network, regardless of the topology of the network.

For simplicity and clarity, the illustration in each of FIGS. 1, 3, and 7 and the following description relate to only one fiber between adjacent nodes and one signal direction, clockwise, around the illustrated ring. However, it should be understood that the same comments apply for multiple fibers between nodes and for opposite signal directions (on the same or different fibers) around the ring, as for example may be the case with known two-fiber or four-fiber bidirectional line switched ring networks.

The optical network of each of FIGS. 1, 3, and 7 is a WDM network, for which the network connectivity is generally different for different optical wavelengths or wavebands. For brevity, the following description refers only to wavebands, but it can be appreciated that the same comments can apply for individual wavelengths (viewed alternatively, a waveband can be considered to comprise a group of wavelengths or an individual wavelength). In order to illustrate by way of example different network connectivity for different wavebands or different parts of the optical spectrum, these are represented in the drawings by various forms of broken lines (e.g. dashed and chained lines). It can be appreciated that these broken lines in the drawings do not represent further fibers, but represent different parts of the optical spectrum carried on the fiber(s) represented by solid lines.

Referring to FIG. 1, a dashed line 2 indicates that optical signals in a first optical waveband B1 are added at the node N7 and are conducted in a clockwise direction around part of the ring, via the nodes N8 and N1 and the amplifier A1, to the node N2 where they are dropped, the adding and dropping functions being carried out using add/drop demultiplexer-multiplexers (ADMs) in known manner. A similarly dashed line 4 indicates that optical signals in this optical waveband B1 are also added at the node N3 and are conducted in a clockwise direction around part of the ring, via the nodes N4 and N5, the amplifier A2, and the node N6, to the node N7 where they are dropped. Similarly, a dotted line 6 in FIG. 1 indicates that optical signals in a second optical waveband B2 are added at the node N8 and are dropped at the node N2, and a chained line 8 indicates that optical signals in a third optical waveband B3 are added at the node N1 and are dropped at the node N4.

FIG. 2 illustrates optical loop gain around the optical network ring of FIG. 1, i.e. total optical signal gain from any point clockwise around the ring back to the same point, as a function of optical wavelength. This gain is dependent upon the optical path losses around the ring for different wavelengths, offset by gain of the amplifiers A1 and A2, which are typically broadband optical amplifiers.

Within the waveband B1, as shown in FIG. 2 the loop gain is very small (i.e. there is high attenuation) because the ADMs, comprising optical filters, provided in the nodes N7, N2, and N3 for adding and/or dropping signals in this waveband substantially interrupt the optical path. Similarly, ADMs in the nodes N8 and N3 for the waveband B2 result in a small loop gain in this waveband, and ADMs in the nodes N1 and N4 for the waveband B3 result in a small loop gain in this waveband. For simplicity in FIG. 2 it is assumed that the wavebands B1 to B3 are adjacent one another, but this need not be the case.

As indicated in FIG. 2 by references 10, the loop gain at wavelengths below and above the wavebands B1 to B3 is relatively high. Similarly, as indicated by references 12, the loop gain at wavelengths between adjacent wavebands B1 to B3 is relatively high. As discussed in the Background above, ASE can occur at these wavelengths as a result of the relatively high loop gain, resulting in degraded communications for optical signals at all wavelengths.

As also discussed in the Background above, this problem can be addressed by reducing the loop gain due to the amplifiers around the ring together with careful power management, or by breaking the optical path at all wavelengths by making at least one of the nodes a hub at which all optical wavebands are demultiplexed and re-multiplexed, or introducing selective filters also with demultiplexing and re-multiplexing of the optical wavebands, but such solutions involve disadvantages as discussed above. Further, such solutions become increasingly disadvantageous with increasing topological complexity of the optical network.

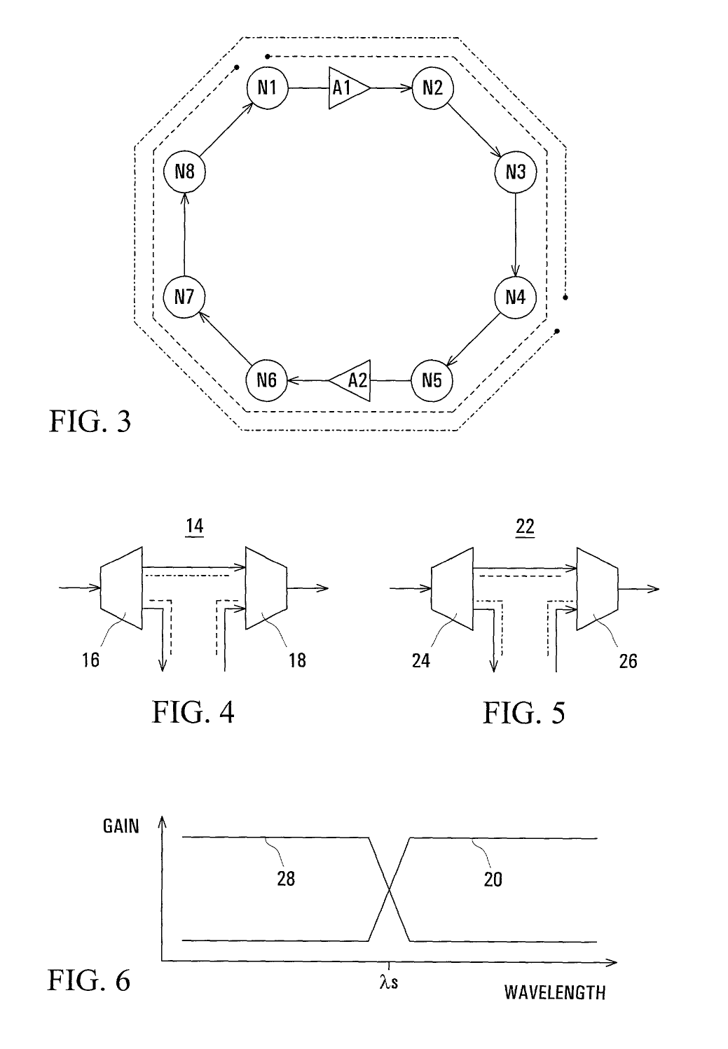

In the WDM optical network of FIG. 3 the network connectivity among the nodes is provided, in accordance with an embodiment of this invention, in a manner which facilitates avoiding ASE loops throughout the optical spectrum, without unduly restricting the network topology or unduly increasing the electro-optical equipment required in the ring. The illustration in FIG. 3 is provided as only one simple example of numerous possible network arrangements any of which can be provided in accordance with the invention.

The WDM optical network of FIG. 3 is further described below with additional reference to FIGS. 4 to 6. FIG. 4 illustrates an optical seam filter 14 provided in (for example) the node N1 of FIG. 3, and FIG. 5 illustrates an optical seam filter 22 provided in (for example) the node N4 of FIG. 3. FIG. 6 illustrates a gain characteristic 20 of the optical seam filter 14, and a gain characteristic 28 of the optical seam filter 22.

Referring to FIG. 4, the optical seam filter 14 in the node N1 comprises two optical spectral band filters 16 and 18, arranged in a manner similar to that of known optical band filters provided for example in ADMs. Thus the filter 16 has an input port to which an optical signal is supplied, a drop port to which optical signals at wavelengths within the pass band of the filter are coupled from the input port, and a through port to which optical signals at other wavelengths are coupled from the input port. Similarly, the filter 18 has an output port for an optical signal, an add port from which optical signals at wavelengths within the pass band of the filter are coupled to the output port, and a through port which is coupled to the through port of the filter 16 and from which optical signals at other wavelengths are also coupled to the output port. The filters 16 and 18 have the same pass band, and can be the same as one another as is known for optical ADMs.

Although as illustrated in FIG. 4 and described above the optical seam filter 14 comprises two optical spectral band filters 16 and 18, an optical seam filter can instead comprise only one spectral band filter, for example only the filter 16 with its drop port, only the filter 18 with its add port, or an optical filter that simply stops the appropriate spectral band, e.g. a two-port absorptive filter. Accordingly, it can be appreciated that it is not necessary in general, to provide an optical seam for avoiding an ASE loop, for an optical seam filter to drop and add the filtered spectral band or to include add/drop functionality. However, optical seam filters with add/drop functionality can be particularly convenient and desirable, for example in fiber mesh networks.

Similarly and as illustrated in FIG. 5, the optical seam filter 22 in the node N4 comprises two optical spectral band filters 24 and 26, arranged in the same manner as the filters 16 and 18 of the optical seam filter 14. The filters 24 and 26 have the same pass band as one another, separate from that of the filters 16 and 18, as shown in FIG. 6. The optical seam filter 22 could also, as indicated above, instead comprise only a single spectral band filter with or without add/drop functionality, in order to provide an optical seam.

As shown in FIG. 6, the gain characteristics of the optical seam filters 14 and 22 divide the overall optical spectrum of the optical network into two separate (in this example, non-overlapping) spectral bands, each of which typically encompasses a plurality of optical wavebands (not shown in FIG. 6). As shown by the gain characteristics 20 and 28 in FIG. 6, below a separation wavelength λs between the two spectral bands the optical seam filter 14 in the node N1 has low gain (high loss) for added/dropped optical signals so that optical signals at wavelengths in this spectral band are coupled through this filter via its through ports, and conversely the optical seam filter 22 in the node N4 has high gain (low loss) so that it adds/drops optical signals at wavelengths in this spectral band. Above the separation wavelength λs the optical seam filter 14 in the node N1 has high gain so that it adds/drops optical signals at wavelengths in this spectral band, whereas the optical seam filter 22 in the node N4 has low gain so that optical signals at wavelengths in this spectral band are coupled through this filter via its through ports. At wavelengths in the region of the separation wavelength λs, each optical seam filter provides loss for the optical path via its through ports.

By way of example, where the optical network accommodates optical signals in the so-called C and L bands, one of the two spectral bands into which the optical spectrum is divided may comprise the C band and the other may comprise the L band, each spanning for example 32 optical wavelengths. As another example, optical wavelengths in only one such band may be divided between the two spectral bands. More generally, the optical spectrum may be divided in any desired manner into two or more separate spectral bands using any form of optical seam filters.

In FIGS. 4 and 5 paths of optical signals at wavelengths within the upper and lower spectral bands, respectively above and below the separation wavelength λs, are represented by dashed and chained lines respectively. In FIG. 3, similar dashed and chained lines illustrate the resulting network connectivity for optical signals at wavelengths within the respective spectral bands.

More particularly, it can be seen from the dashed line in FIG. 3 that for optical signals at wavelengths in the upper spectral band the optical seam filter 14 in the node N1 provides an interruption (represented by dots in FIG. 3) of the optical loop that would otherwise exist around the fiber ring network at these wavelengths, because optical signals at these wavelengths are added/dropped at the node N1 as shown by FIG. 4. Conversely, it can be seen from the chained line in FIG. 3 that for optical signals at wavelengths in the lower spectral band the optical seam filter 22 in the node N4 provides an interruption (again represented by dots in FIG. 3) of the optical loop that would otherwise exist around the fiber ring network at these wavelengths, because optical signals at these wavelengths are added/dropped at the node N4 as shown by FIG. 5. At wavelengths between the spectral bands, in the region of the separation wavelength λs, the optical seam filters 14 and 22 both provide substantial loss in the optical loop.

Consequently, it can be seen that the provision of the optical seam filters 14 and 22, for respective separate parts of the optical spectrum in different nodes around the network ring, ensures that at all wavelengths within the optical spectrum there is a sufficient loop loss that no ASE loops are formed, so that build-up of ASE in the network is avoided.

As indicated above, FIGS. 3 to 6 relate to a relatively simple network, for which the choices of particular nodes for the optical seam filters and allocations of spectral bands is relatively easy. With more complex networks, network planning can be used to avoid ASE loops in the same manner while selecting the spectral bands and allocation of optical seam filters to respective nodes so that minimal additional filters are required, with consequent minimal additional costs in the network. Such network planning can also take into account the positioning and gains of the amplifiers, as well as the separation of the spectral bands as described above to ensure that all potential spectral components of an optical signal undergo sufficient loss to avoid ASE loops.

Optical communications among the nodes of the network are allocated to optical wavebands within the spectral bands as a part of such network planning to minimize additional filter requirements. For example, in the network shown in FIG. 3, an optical signal to be communicated from the node N3 to the node N6 is allocated to an optical waveband in the upper spectral band (dashed line), rather than to the lower spectral band (chained line) for which it would be subject to add/drop processing in the intermediate node N4. Conversely, an optical signal to be communicated from the node N8 to the node N2 is allocated to an optical waveband in the lower spectral band (chained line), rather than to the upper spectral band (dashed line) for which it would be subject to add/drop processing in the intermediate node N1. An optical signal to be communicated from the node N6 to the node N8 can be allocated to an optical waveband in either spectral band, because there is no optical seam filter between these nodes.

Considered generally, it can be appreciated from the above examples that in accordance with embodiments of the invention, for a potential ASE loop, the optical spectrum is divided into a plurality, i.e. two or more, separate spectral bands, and optical seam filters, which may provide add/drop functionality for the spectral bands, are provided at a plurality of nodes around the loop in order to interrupt the optical path in such nodes for the respective spectral bands. In this manner, different spectral bands are optically interrupted at different nodes, and optical wavelengths between the spectral bands are attenuated, so that an actual ASE loop is avoided. Network planning is used to determine positions of the spectral band ADMs or optical seam filters, allocations of optical wavebands to optical signals communicated among the nodes, positions and gains of amplifiers, etc., in accordance with requirements for any particular optical network.

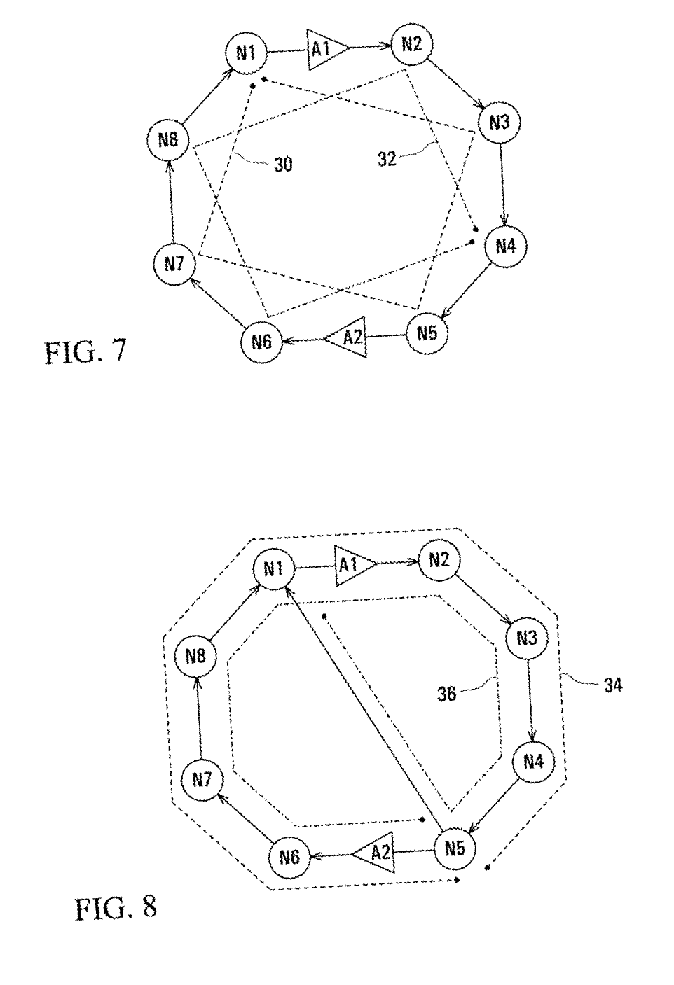

Although the above description relates to a relatively simple optical ring network, it can be appreciated that the principles of the invention can be applied to other network arrangements which may be much more complex. By way of further example, FIG. 7 illustrates parts of another WDM optical network in accordance with a further embodiment of this invention.

In FIG. 7, the WDM optical network has the same form as that of FIGS. 1 and 3, but has a sub-mesh network connectivity as illustrated by dashed and chained lines 30 and 32 respectively. In this example a first sub-mesh comprises the nodes N1, N3, N5, and N7 and uses wavebands in the upper spectral band, for which as described above the node N1 includes an optical seam filter providing an optical loop interruption for this spectral band, and a second sub-mesh comprises the nodes N2, N4, N6, and N8 and uses wavebands in the lower spectral band, for which as described above the node N4 includes an optical seam filter providing an optical loop interruption for this spectral band. Point-to-point links between adjacent ones of the nodes N1 to N8 can use either spectral band. As in FIG. 3, in FIG. 7 dots represent the optical path interruptions or optical seams for the respective spectral bands at the nodes N1 and N4.

FIG. 8 illustrates another form of optical seam filter, which comprises an optical interleaver 34. In FIG. 8, the interleaver 34 is arranged as a deinterleaver which serves to split an incoming optical signal into two spectral bands. More particularly, as illustrated in FIG. 8 adjacent to its optical paths, the interleaver 34 is supplied with an optical signal comprising signal components, numbered 1 to 6 in FIG. 8, with a particular frequency spacing, and separates these into odd-numbered components 1, 3, and 5 at one of its outputs and even-numbered components 2, 4, and 6 at the other of its outputs. The odd-numbered optical signal components constitute one spectral band, and the even-numbered components constitute another separate and distinct spectral band within the optical spectrum.

It can be appreciated that the interleaver of FIG. 8 can be used as a spectral band filter in embodiments of the invention in a similar manner to the spectral band filters 16 and 24 as described above to provide an optical seam filter, optionally with the optical components at one of its outputs being dropped and demultiplexed. Conversely, a similar interleaver can be used in a similar manner to the spectral band filters 18 and 26 as described above to provide an optical seam filter, optionally with the (odd or even) optical components at one of its inputs being added, and two interleavers can be used, in a similar manner to the spectral band filters described above, to provide add/drop multiplexing as well as optical seam filtering for a spectral band.

It can also be appreciated that spectral band filters as illustrated in FIGS. 3 and 4, and interleavers as shown in FIG. 8, can be cascaded in known manner to divide the optical spectrum into more than two separate spectral bands. For example, an optical WDM signal comprising optical components with a spacing of 50 GHz can be separated into two spectral bands using a 50 GHz interleaver 34 as shown in FIG. 8, and each of these can be further separated in a similar manner into two spectral bands using a respective 100 GHz interleaver, thereby producing four separate spectral bands each with optical components having a spacing of 200 GHz.

Although particular embodiments of the invention are described above, it can be appreciated that numerous modifications, variations, and adaptations may be made without departing from the scope of the invention as defined in the claims.

1. A method of avoiding an amplified spontaneous emission (ASE) loop in an optical network comprising a plurality of nodes coupled via optical paths, the nodes and optical paths forming a loop in the network, comprising the steps of:
dividing an optical spectrum of the optical network into a plurality of separate spectral bands; and
providing a plurality of optical seam filters, each optically interrupting optical signals in a respective spectral band, distributed among a plurality of nodes around the loop whereby optical signals in at least one spectral band are optically interrupted in a different node from optical signals in at least one other spectral band, the optical seam filters providing at least one optical interruption around the loop for each spectral band.

2. A method as claimed in claim 1 and including the step of, for at least one node including an optical seam filter for a spectral band, add/drop multiplexing optical signals of the spectral band at the node.

3. A method as claimed in claim 1 wherein the optical spectrum is divided into at least two non-overlapping spectral bands each including a plurality of optical wavelengths.

4. A method as claimed in claim 1 wherein the optical spectrum is divided into at least two spectral bands having interleaved optical wavelengths.

5. A method of avoiding amplified spontaneous emission (ASE) loops in an optical network comprising a plurality of nodes coupled via optical paths, the nodes and optical paths forming a plurality of loops in the network, comprising avoiding an ASE loop in each of a plurality of said loops by the method of claim 1.

6. A method as claimed in claim 5 and including the step of, for at least one node including an optical seam filter for a spectral band, add/drop multiplexing optical signals of the spectral band at the node.

7. A method as claimed in claim 5 wherein the optical spectrum is divided into at least two non-overlapping spectral bands each including a plurality of optical wavelengths.

8. A method as claimed in claim 5 wherein the optical spectrum is divided into at least two spectral bands having interleaved optical wavelengths.

9. An optical network comprising a plurality of nodes coupled via optical paths, the nodes and paths forming a loop in the network, wherein an optical spectrum for communications among the nodes via the optical paths comprises a plurality of separate spectral bands, and wherein a plurality of nodes in the loop each comprise at least one optical seam filter for optically interrupting the loop for optical signals in a respective one of the spectral bands, all of the spectral bands of the optical spectrum thereby being optically interrupted by respective optical seam filters distributed among at least two nodes in the loop.

10. An optical network as claimed in claim 9 wherein at least one of the plurality of nodes in the loop comprising an optical seam filter further comprises an optical add/drop multiplexer for add/drop multiplexing optical signals of the respective spectral band at the node.

11. An optical network as claimed in claim 8 wherein the optical spectrum comprises at least two non-overlapping spectral bands each including a plurality of optical wavelengths.

12. An optical network as claimed in claim 8 wherein the optical spectrum comprises at least two spectral bands having interleaved optical wavelengths.

13. An optical network comprising a plurality of nodes coupled via optical paths, the nodes and paths forming a plurality of loops in the network, wherein an optical spectrum for communications among the nodes via the optical paths comprises a plurality of separate spectral bands, and wherein a plurality of nodes in each of a plurality of the loops each comprise at least one optical seam filter for optically interrupting the respective loop for optical signals in a respective one of the spectral bands, all of the spectral bands of the optical spectrum thereby being optically interrupted by respective optical seam filters distributed among at least two nodes in the respective one of the plurality of loops.

14. An optical network as claimed in claim 13 wherein at least one of the plurality of nodes in the loop comprising an optical seam filter further comprises an optical add/drop multiplexer for add/drop multiplexing optical signals of the respective spectral band at the node.

15. An optical network as claimed in claim 13 wherein the optical spectrum comprises at least two non-overlapping spectral bands each including a plurality of optical wavelengths.

16. An optical network as claimed in claim 13 wherein the optical spectrum comprises at least two spectral bands having interleaved optical wavelengths.

17. A method of avoiding amplified spontaneous emission (ASE) loops in an optical network comprising nodes coupled via optical fibers, comprising the steps of, in each of one or more loops each comprising a plurality of the nodes:
providing an optical seam filter for a first spectral band of an optical spectrum of the optical network in a first one of the nodes of the loop thereby to optically interrupt the loop for optical wavelengths within said first spectral band; and
providing an optical seam filter for at least one other spectral band of the optical spectrum in at least one other of the nodes of the loop, thereby to optically interrupt the loop for optical wavelengths in said at least one other spectral band, whereby the loop is optically interrupted for all spectral bands of the optical spectrum.

18. A method as claimed in claim 17 and including the step of, for at least one node including an optical seam filter for a spectral band, add/drop multiplexing optical signals of the spectral band at the node.

19. A method as claimed in claim 18 wherein the optical spectrum is divided into at least two non-overlapping spectral bands each including a plurality of optical wavelengths.

20. A method as claimed in claim 18 wherein the optical spectrum is divided into at least two spectral bands having interleaved optical wavelengths.
